(19) United States
(12) Patent Application Publication
(10) Pub. No.: US 2024/0351909 A1
(43) Pub. Date: Oct. 24, 2024

(54) POROUS AND SPHERICAL COBALT OXIDE PARTICLE AND PREPARATION METHOD THEREFOR

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP EV RECYCLING CO., LTD., Changsha, Hunan (CN)

(72) Inventors: Haijun Yu, Foshan, Guangdong (CN); Yinghao Xie, Foshan, Guangdong (CN); Aixia Li, Foshan, Guangdong (CN); Xuemei Zhang, Foshan, Guangdong (CN); Changdong Li, Foshan, Guangdong (CN)

(21) Appl. No.: 18/687,314

(22) PCT Filed: Feb. 8, 2023
(86) PCT No.: PCT/CN2023/074951

§ 371 Date: Feb. 28, 2024

(30) Foreign Application Priority Data
Apr. 25, 2022 (CN) 202210438279.6

(51) Int. Cl. C01G 51/00; C01G 51/04; H01M 4/02; H01M 4/525

(52) U.S. Cl. CPC C01G 51/42; C01G 51/04; H01M 4/525; C01P 2004/03; C01P 2004/32; C01P 2006/12; C01P 2006/40; H01M 2004/028

(57) ABSTRACT

The present disclosure discloses a porous and spherical cobalt oxide particle and a preparation method therefor. The preparation method includes the following steps: (1) mixing a cobalt salt solution, thiourea, and urea to obtain a mixed solution; (2) heating the mixed solution obtained in step (1) to allow a reaction in an aerobic atmosphere; (3) conducting solid-liquid separation (SLS) to obtain a solid product, and subjecting the solid product to calcination in an aerobic atmosphere to obtain a calcined material; and (4) washing and drying the calcined material obtained in step (3) to obtain the porous and spherical cobalt oxide particle. The cobalt oxide particle prepared by the preparation method has a larger specific surface area (SSA), which can significantly improve a specific capacity of a battery.

### TECHNICAL FIELD

The present disclosure belongs to the technical field of lithium battery cathode materials, and particularly relates to a porous and spherical cobalt oxide particle and a preparation method therefor.

### BACKGROUND

Lithium cobalt oxide (LCO) electrode materials have higher specific capacity and prominent cycling stability, and are widely used in the fields of computer, communication and consumer electronics (3C). With the rapid development of 3C electronic products, manufacturers present higher and higher requirements for the processability and electrochemical performance of LCO cathode materials. LCO, as the first commercialized cathode material for lithium-ion batteries (LIB), is still one of the cathode materials with the highest compacted density in practical applications.

Cobaltosic oxide is an important raw material for preparing LCO cathode materials of LIB, and the physical and chemical properties of cobaltosic oxide have a great impact on the performance of LCO cathode materials and batteries. In addition to higher purity and tap density, battery-grade cobaltosic oxide needs to have a specified morphology and particle size distribution. Cobaltosic oxide prepared by the existing preparation method for cobaltosic oxide has a relatively small specific surface area (SSA), which affects the fast charge and discharge performance of a cathode material. In addition, a battery fabricated by the existing cobaltosic oxide has a relatively small specific capacity, which cannot meet the increasingly-high requirements in the battery industry.

### SUMMARY

The present disclosure is intended to solve at least one of the technical problems existing in the prior art. In view of this, the present disclosure provides a porous and spherical cobalt oxide particle and a preparation method therefor. The cobalt oxide particle prepared by the preparation method has a relatively large SSA, which can significantly improve a specific capacity of a battery.

The above technical objective of the present disclosure is achieved by the following technical solutions.

A preparation method for a porous and spherical cobalt oxide particle is provided, including the following steps: (1) mixing a cobalt salt solution, thiourea, and urea to obtain a mixed solution: (2) heating the mixed solution obtained in step (1) to allow a reaction in an aerobic atmosphere: (3) conducting solid-liquid separation (SLS) to obtain a solid product, and subjecting the solid product to calcination in an aerobic atmosphere to obtain a calcined material: and (4) washing and drying the calcined material obtained in step (3) to obtain the porous and spherical cobalt oxide particle.

Preferably, in step (1), a cobalt salt in the cobalt salt solution may be at least one selected from the group consisting of cobalt sulfate, cobalt chloride, and cobalt nitrate.

Preferably, in step (1), the cobalt salt solution may have a concentration of 0.05 mol/L to 1.0 mol/L.

Preferably, in step (1), a concentration of the thiourea in the mixed solution may be 0.05 mol/L to 1.0 mol/L.

Preferably, in step (1), a concentration of the urea in the mixed solution may be 0.2 mol/L to 2.5 mol/L.

Preferably, in step (2), the reaction may be conducted at 160° C. to 180° C. for 8 h to 12 h.

Preferably, in step (2), the aerobic atmosphere may have a pressure of 0.1 MPa to 1.0 MPa.

Preferably, in step (3), the calcination may be conducted at 500° C. to 750° C. for 2 h to 6 h.

Preferably, in step (4), the washing may be conducted first with ethanol and then with pure water.

Preferably, in step (4), the drying may be conducted at 80° C. to 120° C. for 2 h to 4 h.

Preferably, a preparation method for a porous and spherical cobalt oxide particle is provided, including the following steps:
(1) preparing a cobalt salt solution with a concentration of 0.05 mol/L to 1.0 mol/L, where a cobalt salt in the cobalt salt solution is at least one selected from the group consisting of cobalt sulfate, cobalt chloride, and cobalt nitrate;
(2) adding the cobalt salt solution obtained in step (1) to a high-pressure reactor at an amount being ⅗ to ⅘ of a volume of the high-pressure reactor;
(3) adding thiourea and urea to the high-pressure reactor at amounts enabling a thiourea concentration to be 0.05 mol/L to 1.0 mol/L and a urea concentration to be 0.2 mol/L to 2.5 mol/L;
(4) introducing air into the high-pressure reactor, and controlling an air pressure in the high-pressure reactor at 0.1 MPa to 1.0 MPa;
(5) heating the high-pressure reactor to 160° C. to 180° C. and holding the temperature for 8 h to 12 h to perform a reaction;
(6) after the reaction is completed, conducting SLS, oven drying a resulting solid product, and subjecting a dried solid product to calcination at 500° C. to 750° C. for 2 h to 6 h in an air or oxygen atmosphere to obtain a calcined material; and
(7) washing the calcined material first with ethanol and then with pure water, and drying a calcined material after being washed at 80° C. to 120° C. for 2 h to 4 h to obtain the porous and spherical cobalt oxide particle.

A porous and spherical cobalt oxide particle prepared by the preparation method described above is provided.

An LCO cathode material is provided, which is prepared by subjecting lithium carbonate and the porous and spherical cobalt oxide particle described above to proportional mixing and sintering.

A battery including the LCO cathode material described above is provided.

The present disclosure has the following beneficial effects.

In the preparation method for a porous and spherical cobalt oxide particle of the present disclosure, a mixed solution of a cobalt salt, urea, and thiourea is subjected to a hydrothermal reaction under a specified air pressure in a reactor to obtain a sulfur-doped cobalt-containing particle, and then the sulfur-doped cobalt-containing particle is calcined and washed with water to remove sulfur to obtain a cobalt oxide (a mixture of cobaltosic oxide and cobaltic oxide). Reaction equations are as follows:

Hydrothermal reaction:
CO(NH₂)₂+H₂O→2NH₃+CO₂;
CS(NH₂)₂+2H₂O→2NH₃+CO₂+H₂S;
NH₃·H₂O→NH⁴⁺+OH;
CO₂+H₂0→CO₃²⁻+2H⁺;
Co²⁺+S²⁻→CoS;
4CoS+O₂+2H₂O→4CoSOH;
Co²⁺+(1−0.5y)CO₃²⁻+yOH⁻→Co(OH)_{y}(CO₃)_{1-0.5y}; and
6Co(OH)_{y}(CO₃)_{1-0.5y}+O₂→2Co₃O₄+3yH₂O+(6−3y) CO₂.

Calcination reaction:
2CoSOH+3O₂→Co₂O₃+H₂O+2SO₂.

During the entire hydrothermal reaction, the thiourea is decomposed to produce sulfide ions, and under the induction of sulfide ions, a generated cobalt precipitate can be well crystallized. On one hand, direct addition of sulfide ions that will cause too-fast precipitation and lead to non-spherical waste is avoided. On the other hand, sulfide ions are provided to replace the oxygen atoms in the lattices, and atomic vacancies are produced during the subsequent calcination and water-washing processes for removing sulfur, such that an LCO cathode material prepared accordingly can accommodate more lithium, which improves a specific capacity of the material.

Cobalt can be directly oxidized through the introduction of air and the rise of reaction temperature during the hydrothermal process to obtain hydrothermally-synthesized cobaltosic oxide particles: and the cobalt sulfide precipitate is further oxidized into cobalt hydroxysulfide, and then calcination is conducted to produce cobaltic oxide particles, such that a content of trivalent cobalt is appropriately increased, which can further reduce a cation disordering during subsequent cobalt-lithium sintering and improve the cycling performance of a material.

The cobalt oxide particle finally obtained is porous and spherical and has a larger SSA, which is conducive to the deintercalation/intercalation of lithium ions during a charge and discharge process of a prepared LCO material, and ensures that a battery finally fabricated has prominent fast charge and discharge performance.

### BRIEF DESCRIPTION OF THE DRAWINGS

FIG. 1 is a scanning electron microscopy (SEM) image of the cobalt oxide particle prepared in Embodiment Example 1 of the present disclosure.

### DETAILED DESCRIPTION

The present disclosure is further described below with reference to specific embodiment examples.

### Embodiment Example 1

A preparation method for a porous and spherical cobalt oxide particle was provided, including the following steps:
(1) a cobalt sulfate solution with a concentration of 0.05 mol/L was prepared;
(2) the cobalt sulfate solution obtained in step 1 was added to a high-pressure reactor at an amount being ⅗ of a volume of the high-pressure reactor;
(3) thiourea and urea were added to the high-pressure reactor at amounts enabling a thiourea concentration of 0.05 mol/L and a urea concentration of 0.2 mol/L;
(4) air was introduced into the high-pressure reactor, and an air pressure in the high-pressure reactor was controlled at 0.1 MPa;
(5) the high-pressure reactor was heated to 160° C. and kept at the temperature for 12 h;
(6) after a reaction was completed, SLS was conducted, and a resulting solid product was dried and subjected to calcination at 500° C. for 6 h in an air atmosphere to obtain a calcined material; and
(7) the calcined material was washed first with ethanol and then with pure water, and dried at 80° C. for 4 h to obtain the porous and spherical cobalt oxide particle.

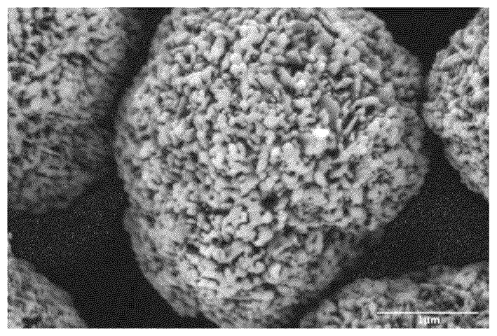

A porous and spherical cobalt oxide particle prepared by the above preparation method was provided. An SEM image of the cobalt oxide particle was shown in FIG. 1.

### Embodiment Example 2

A preparation method for a porous and spherical cobalt oxide particle was provided, including the following steps:
(1) a cobalt chloride solution with a concentration of 0.5 mol/L was prepared;
(2) the cobalt chloride solution obtained in step 1 was added to a high-pressure reactor at an amount being 7/10 of a volume of the high-pressure reactor;
(3) thiourea and urea were added to the high-pressure reactor at amounts enabling a thiourea concentration of 0.5 mol/L and a urea concentration of 1.5 mol/L;
(4) air was introduced into the high-pressure reactor, and an air pressure in the high-pressure reactor was controlled at 0.5 MPa;
(5) the high-pressure reactor was heated to 170° C. and kept at the temperature for 10 h;
(6) after a reaction was completed, SLS was conducted, and a resulting solid product was dried and subjected to calcination at 650° C. for 4 h in an oxygen atmosphere to obtain a calcined material; and
(7) the calcined material was washed first with ethanol and then with pure water, and dried at 100° C. for 3 h to obtain the porous and spherical cobalt oxide particle.

A porous and spherical cobalt oxide particle prepared by the above preparation method was provided.

### Embodiment Example 3

A preparation method for a porous and spherical cobalt oxide particle was provided, including the following steps:
(1) a cobalt nitrate solution with a concentration of 1.0 mol/L was prepared;
(2) the cobalt nitrate solution obtained in step 1 was added to a high-pressure reactor at an amount being ⅘ of a volume of the high-pressure reactor;
(3) thiourea and urea were added to the high-pressure reactor at amounts enabling a thiourea concentration of 1.0 mol/L and a urea concentration of 2.5 mol/L;
(4) air was introduced into the high-pressure reactor, and an air pressure in the high-pressure reactor was controlled at 1.0 MPa;
(5) the high-pressure reactor was heated to 180° C. and kept at the temperature for 8 h;
(6) after a reaction was completed, SLS was conducted, and a resulting solid product was dried and subjected to calcination at 750° C. for 2 h in an oxygen atmosphere to obtain a calcined material; and
(7) the calcined material was washed first with ethanol and then with pure water, and dried at 120° C. for 2 h to obtain the porous and spherical cobalt oxide particle.

A porous and spherical cobalt oxide particle prepared by the above preparation method was provided.

### Comparative Example 1

A preparation method for a cobalt oxide particle was provided, including the following steps:
(1) a cobalt sulfate solution with a concentration of 0.05 mol/L was prepared;
(2) the cobalt sulfate solution obtained in step 1 was added to a high-pressure reactor at an amount being ⅗ of a volume of the high-pressure reactor;
(3) urea was added to the high-pressure reactor at an amount enabling a urea concentration of 0.2 mol/L;
(4) the high-pressure reactor was heated to 160° C. and kept at the temperature for 12 h;
(5) after a reaction was completed, SLS was conducted, and a resulting solid product was dried and subjected to calcination at 500° C. for 6 h in an air atmosphere to obtain a calcined material; and
(6) the calcined material was washed first with ethanol and then with pure water, and dried at 80° C. for 4 h to obtain the cobalt oxide particle.

A cobalt oxide particle prepared by the above preparation method was provided.

### Comparative Example 2

A preparation method for a cobalt oxide particle was provided, including the following steps:
(1) a cobalt chloride solution with a concentration of 0.5 mol/L was prepared;
(2) the cobalt chloride solution obtained in step 1 was added to a high-pressure reactor at an amount being 7/10 of a volume of the high-pressure reactor;
(3) urea was added to the high-pressure reactor at an amount enabling a urea concentration of 1.5 mol/L;
(4) the high-pressure reactor was heated to 170° C. and kept at the temperature for 10 h;
(5) after a reaction was completed, SLS was conducted, and a resulting solid product was dried and subjected to calcination at 650° C. for 4 h in an oxygen atmosphere to obtain a calcined material; and
(6) the calcined material was washed first with ethanol and then with pure water, and dried at 100° C. for 3 h to obtain the cobalt oxide particle.

A cobalt oxide particle prepared by the above preparation method was provided.

### Comparative Example 3

A preparation method for a cobalt oxide particle was provided, including the following steps:
(1) a cobalt nitrate solution with a concentration of 1.0 mol/L was prepared;
(2) the cobalt nitrate solution obtained in step 1 was added to a high-pressure reactor at an amount being ⅘ of a volume of the high-pressure reactor;
(3) urea was added to the high-pressure reactor at an amount enabling a urea concentration of 2.5 mol/L;
(4) the high-pressure reactor was heated to 180° C. and kept at the temperature for 8 h;
(5) after a reaction was completed, SLS was conducted, and a resulting solid product was dried and subjected to calcination at 750° C. for 2 h in an oxygen atmosphere to obtain a calcined material; and
(6) the calcined material was washed first with ethanol and then with pure water, and dried at 120° C. for 2 h to obtain the cobalt oxide particle.

A cobalt oxide particle prepared by the above preparation method was provided.

### Test Example

1. The SSA was tested for the cobalt oxide particles of Embodiment Examples 1 to 3 and Comparative Examples 1 to 3 respectively, and test results were shown in Table 1:

TABLE 1
SSA test results

| | SSA (m²/g) |
|---|---|
| Embodiment Example 1 | 6.7 |
| Embodiment Example 2 | 5.8 |
| Embodiment Example 3 | 5.3 |
| Comparative Example 1 | 3.8 |
| Comparative Example 2 | 3.6 |
| Comparative Example 3 | 3.2 |

2. The cobalt oxide obtained in each of Embodiment Examples 1 to 3 and Comparative Examples 1 to 3 was mixed with lithium carbonate in a Li: Co molar ratio of 1.06, and a resulting mixture was then subjected to high-temperature solid-phase sintering at 1,000° C. for 12 h in a pusher kiln to obtain an LCO cathode material. The LCO cathode material obtained from each of Embodiment Examples 1 to 3 and Comparative Examples 1 to 3, acetylene black (as a conductive agent), and polyvinylidene fluoride (PVDF) (as a binder) were weighed and mixed in a ratio of 92:4:4, then a specified amount of an organic solvent N-methylpyrrolidone (NMP) was added, and a resulting mixture was stirred and coated on an aluminum foil to obtain a positive electrode sheet: and then with a metal lithium sheet as a negative electrode, a CR2430 button battery was assembled in an argon-filled glove box. An electrical performance test was conducted on a CT2001A Land test system under the following conditions: voltage: 3.0 V to 4.48 V, current density: 1 C=180 mAh/g, and test temperature: 25±1° C. Test results were shown in Table 2.

TABLE 2
Electrical performance test results

| | | Capacity retention rate |
|---|---|---|
| | 0.1 C/4.48 V | after 600 cycles at 0.1 |
| | Discharge capacity, mAh/g | C/4.48 V |
| Embodiment | 248.6 | 86% |
| Example 1 | | |
| Embodiment | 249.9 | 86% |
| Example 2 | | |
| Embodiment | 248.3 | 84% |
| Example 3 | | |
| Comparative | 183.1 | 76% |
| Example 1 | | |
| Comparative | 186.7 | 75% |
| Example 2 | | |
| Comparative | 184.6 | 76% |
| Example 3 | | |

It can be seen from Table 1 that the porous and spherical cobalt oxide particle of the present disclosure has an SSA of 5.3 m²/g or higher, which can reach 6.7 m²/g at most. Moreover, it can be seen from the comparison between Embodiment Example 1 and Comparative Example 1, the comparison between Embodiment Example 2 and Comparative Example 2, and the comparison between Embodiment Example 3 and Comparative Example 3 that, if thiourea is not added and air is not introduced during the hydrothermal reaction, with other reaction conditions unchanged, the SSA of the cobalt oxide particle finally prepared will be greatly reduced.

It can be seen from Table 2 that a battery assembled by an LCO cathode material made from the porous and spherical cobalt oxide particle of the present disclosure has a larger specific capacity, a discharge capacity at 0.1 C/4.48 V of 248.3 mAh/g or higher, which can reach 249.9 mAh/g at most, and a capacity retention rate of 84% or higher after 600 cycles at 0.1 C/4.48 V (which can reach 86% at most). Moreover, it can be seen from the comparison between Embodiment Example 1 and Comparative Example 1, the comparison between Embodiment Example 2 and Comparative Example 2, and the comparison between Embodiment Example 3 and Comparative Example 3 that, if thiourea is not added and air is not introduced during the hydrothermal reaction, with other reaction conditions unchanged, the discharge capacity (at 0.1 C/4.48 V) and the capacity retention rate after 600 cycles of the battery finally assembled will be greatly reduced.

The above embodiment examples are preferred embodiments of the present disclosure. However, the embodiments of the present disclosure are not limited by the above embodiment examples. Any change, modification, substitution, combination, and simplification made without departing from the spiritual essence and principle of the present disclosure should be an equivalent replacement modes, and all are included in the protection scope of the present disclosure.

1. A preparation method for a porous and spherical cobalt oxide particle, comprising the following steps:
(1) mixing a cobalt salt solution, thiourea, and urea to obtain a mixed solution;
(2) heating the mixed solution obtained in step (1) to allow a reaction in an aerobic atmosphere;
(3) conducting solid-liquid separation (SLS) to obtain a solid product, and subjecting the solid product to calcination in an aerobic atmosphere to obtain a calcined material; and
(4) washing and drying the calcined material obtained in step (3) to obtain the porous and spherical cobalt oxide particle.

2. The preparation method for a porous and spherical cobalt oxide particle according to claim 1, wherein in step (1), a cobalt salt in the cobalt salt solution is at least one selected from the group consisting of cobalt sulfate, cobalt chloride, and cobalt nitrate.

3. The preparation method for a porous and spherical cobalt oxide particle according to claim 1, wherein in step (1), the cobalt salt solution has a concentration of 0.05 mol/L to 1.0 mol/L.

4. The preparation method for a porous and spherical cobalt oxide particle according to claim 1, wherein in step (1), a concentration of the thiourea in the mixed solution is 0.05 mol/L to 1.0 mol/L.

5. The preparation method for a porous and spherical cobalt oxide particle according to claim 1, wherein in step (1), a concentration of the urea in the mixed solution is 0.2 mol/L to 2.5 mol/L.

6. The preparation method for a porous and spherical cobalt oxide particle according to claim 1, wherein in step (2), the reaction is conducted at 160° C. to 180° C. for 8 h to 12 h.

7. The preparation method for a porous and spherical cobalt oxide particle according to claim 1, wherein in step (2), the aerobic atmosphere has a pressure of 0.1 MPa to 1.0 MPa.

8. The preparation method for a porous and spherical cobalt oxide particle according to claim 1, wherein in step (3), the calcination is conducted at 500° C. to 750° C. for 2 h to 6 h.

9. A porous and spherical cobalt oxide particle prepared by the preparation method according to claim 1.

10. A lithium cobalt oxide cathode material prepared by subjecting lithium carbonate and the porous and spherical cobalt oxide particle according to claim 9 to proportional mixing and sintering.

11. A porous and spherical cobalt oxide particle prepared by the preparation method according to claim 2.

12. A porous and spherical cobalt oxide particle prepared by the preparation method according to claim 3.

13. A porous and spherical cobalt oxide particle prepared by the preparation method according to claim 4.

14. A porous and spherical cobalt oxide particle prepared by the preparation method according to claim 5.

15. A porous and spherical cobalt oxide particle prepared by the preparation method according to claim 6.

16. A porous and spherical cobalt oxide particle prepared by the preparation method according to claim 7.

17. A porous and spherical cobalt oxide particle prepared by the preparation method according to claim 8.

18. A lithium cobalt oxide cathode material prepared by subjecting lithium carbonate and the porous and spherical cobalt oxide particle according to claim 11 to proportional mixing and sintering.

19. A lithium cobalt oxide cathode material prepared by subjecting lithium carbonate and the porous and spherical cobalt oxide particle according to claim 12 to proportional mixing and sintering.

20. A lithium cobalt oxide cathode material prepared by subjecting lithium carbonate and the porous spherical and cobalt oxide particle according to claim 13 to proportional mixing and sintering.
